(19) United States
(12) Patent Application Publication
(10) Pub. No.: US 2026/0001769 A1
(43) Pub. Date: Jan. 1, 2026

(54) TWO-DIMENSIONAL PARTICLE, AND ELECTROCONDUCTIVE FILM AND METHOD FOR PRODUCING SAME

(71) Applicant: Murata Manufacturing Co., Ltd., Nagaokakyo-shi (JP)

(72) Inventors: Yuusuke OGAWA, Nagaokakyo-shi (JP); Takamasa NAKAMURA, Nagaokakyo-shi (JP); Seiji KAWASAKI, Nagaokakyo-shi (JP)

(21) Appl. No.: 19/317,445

(22) Filed: Sep. 3, 2025

Related U.S. Application Data
(63) Continuation of application No. PCT/JP2024/010284, filed on Mar. 15, 2024.

(30) Foreign Application Priority Data
Mar. 24, 2023 (JP) 2023-048140

(51) Int. Cl. C01B 32/921; C01B 32/914; C09C 3/06; C09C 3/08

(52) U.S. Cl. CPC C01B 32/921; C01B 32/914; C09C 3/06; C09C 3/08; C01P 2002/54; C01P 2004/20; C01P 2006/40

(57) ABSTRACT

A two-dimensional particle that includes: one or plural layers that comprise a layer body represented by: MₘXₙ, wherein Mis at least one metal of Group 3, 4, 5, 6, or 7; X is a carbon atom, a nitrogen atom, or a combination thereof; n is 1 to 4; and m is more than n but not more than 5, a modifier or terminal T exists on a surface of the layer body, wherein T is at least one selected from a hydroxyl group, a fluorine atom, a chlorine atom, an iodine atom, an oxygen atom, a chlorine atom, a phosphorus atom, and a hydrogen atom; and a hydrocarbon compound exists on the one or plural layers.

### CROSS REFERENCE TO RELATED APPLICATIONS

The present application is a continuation of International application No. PCT/JP2024/010284, filed Mar. 15, 2024, which claims priority to Japanese Patent Application No. 2023-048140, filed Mar. 24, 2023, the entire contents of each of which are incorporated herein by reference.

### TECHNICAL FIELD

The present disclosure relates to a two-dimensional particle, an electroconductive film, and a method for producing the same.

### BACKGROUND ART

In recent years, MXene has been attracting attention as a new material having an electrical conduction property. MXene is a type of so-called two-dimensional material, and as will be described later, is a layered material in the form of one or plural layers. In general, MXene is in the form of a particle (which may comprise a powder, a flake, a nanosheet, and the like) of such a layered material.

Patent Document 1 describes that MXene represented by Ti₃C₂(OH)₂ is obtained by immersing a Ti₂AlC-TiC mixture in a HF solution.

Non-Patent Document 1 describes that delamination of multilayer MXene was performed by hand shaking using TMAOH (tetramethylammonium hydroxide), and delamination of multilayer MXene was performed by further performing an ultrasonic treatment using DMSO (dimethyl sulfoxide).

Patent Document 1: US 2014/0162130 A

Non-patent Document 1: Guidelines for Synthesis and Processing of Two-Dimensional Titanium Carbide (Ti3C2Tx MXene) Chem. Mater. 2017, 29, 7633-7644

### SUMMARY OF THE DISCLOSURE

Although MXenes in Patent Document 1 and Non-patent Document 1 exhibit an electrical conduction property, the stability of the electrical conductivity was not sufficiently satisfactory.

The present disclosure is to provide a two-dimensional particle capable of realizing an electroconductive film having favorable electrical conductivity stability, and preferably to provide a two-dimensional particle capable of realizing an electroconductive film having favorable electrical conductivity stability even in a high-temperature environment. The present disclosure is also to provide an electroconductive film comprising such a two-dimensional particle and a method for producing such a two-dimensional particle.

The two-dimensional particle of the present disclosure comprises one or plural layers that comprise a layer body represented by a formula below:

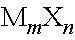

wherein M is at least one metal of Group 3, 4, 5, 6, or 7; X is a carbon atom, a nitrogen atom, or a combination thereof; n is 1 to 4, and; m is more than n but not more than 5, and
a modifier or terminal T (where T is at least one selected from the group consisting of a hydroxyl group, a fluorine atom, a chlorine atom, an iodine atom, an oxygen atom, a chlorine atom, a phosphorus atom, and a hydrogen atom) exists on a surface of the layer body; and
a hydrocarbon compound exists on the one or plural layers.

The method for producing a two-dimensional particle of the present disclosure comprises: heating a precursor particle in the presence of an organic compound under conditions of an absolute pressure of less than 1,013 hPa and a boiling point of the organic compound or higher to obtain a two-dimensional particle,
wherein the precursor particle comprises one or plural layers,
wherein the one or plural layers comprise a layer body and a modifier or terminal T,
wherein the layer body is represented by a formula below:

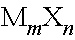

wherein M is at least one metal of Group 3, 4, 5, 6, or 7; X is a carbon atom, a nitrogen atom, or a combination thereof; n is 1 to 4; and m is more than n but not more than 5,
wherein the modifier or terminal T (where T is at least one selected from the group consisting of a hydroxyl group, a fluorine atom, a chlorine atom, an iodine atom, an oxygen atom, a chlorine atom, a phosphorus atom, and a hydrogen atom) exists on a surface of the layer body, and
wherein the organic compound has a melting point of 20° C. or lower.

According to the present disclosure, a two-dimensional particle capable of realizing a film in which a decrease in electrical conductivity is suppressed may be provided, and preferably, a two-dimensional particle capable of realizing an electroconductive film in which a decrease in electrical conductivity is suppressed even in a high-temperature environment may be provided. The present disclosure may also provide an electroconductive film comprising such a two-dimensional particle and a method for producing such a two-dimensional particle.

### BRIEF DESCRIPTION OF THE DRAWINGS

FIGS. 1(a) and 1(b) are schematic cross-sectional views showing a MXene particle of a layered material in one embodiment of the present disclosure, and FIG. 1(a) shows a single-layer MXene particle, and FIG. 1(b) shows a multilayer (exemplarily, two-layer) MXene particle.

FIG. 2 is a schematic cross-sectional view showing a film in one embodiment of the present disclosure.

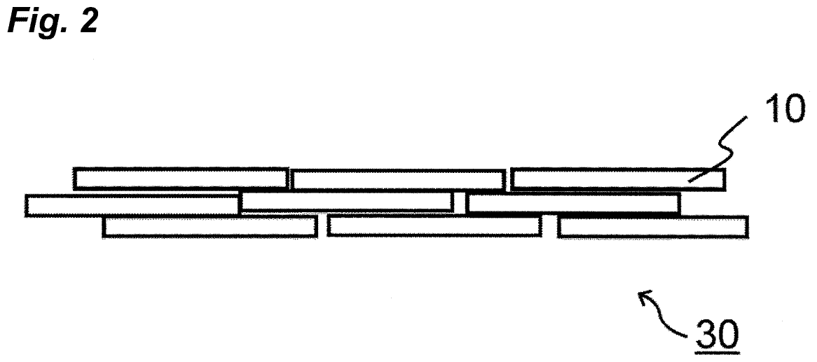

### DESCRIPTION OF THE PREFERRED EMBODIMENTS

### First Embodiment: Two-Dimensional Particle

Hereinafter, a two-dimensional particle in one embodiment of the present disclosure will be described.

The two-dimensional particle of the present disclosure comprises one or plural layers and a hydrocarbon compound.

The one or plural layers comprise a layer body and a modifier or terminal T,
wherein the layer body is represented by a formula below:

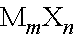

wherein M is at least one metal of Group 3, 4, 5, 6, or 7; X is a carbon atom, a nitrogen atom, or a combination thereof; n is not less than 1 and not more than 4, and m is more than n but not more than 5;
wherein the modifier or terminal T (where Tis at least one selected from the group consisting of a hydroxyl group, a fluorine atom, a chlorine atom, an iodine atom, an oxygen atom, a chlorine atom, a phosphorus atom, and a hydrogen atom) exists on a surface of the layer body, and
wherein the hydrocarbon compound exists on the one or plural layers.

According to the present disclosure, a two-dimensional particle capable of realizing a film in which a decrease in electrical conductivity is suppressed may be provided, and preferably, a two-dimensional particle capable of realizing an electroconductive film in which a decrease in electrical conductivity is suppressed even in a high-temperature environment may be provided. The present disclosure should not be limited to a specific theory, but the reason for the above effect exhibited by the two-dimensional particle of the present disclosure is considered as follows.

That is, one of the causes of the decrease in electrical conductivity of MXene may be attributable to the oxidation of MXene. In the two-dimensional particle of the present disclosure, since a hydrocarbon compound exists on the layer of MXene, the oxidation of the layer of MXene is considered to be suppressed even in a high-temperature environment. As a result, a film with a suppressed decrease in electrical conductivity may be realized, and particularly, an electroconductive film a suppressed decrease in electrical conductivity may be realized even in a high-temperature environment.

In the present disclosure, the cases where “a hydrocarbon compound exists on a layer” comprise both the case where the hydrocarbon compound is physically bonded to the layer; and the case where the hydrocarbon compound is not bonded to the layer, and may comprise all the case where the hydrocarbon compound is not bonded to the layer; the case where the hydrocarbon compound is in contact with the layer; and the case where the hydrocarbon compound is not in contact with the layer.

In the present disclosure, when an element is referred to as an “atom”, the oxidation number of the element is not limited to zero, and may be any number within the range of possible oxidation number of the element.

In the present disclosure, the “hydrocarbon compound” means a compound formed of a carbon atom and a hydrogen atom. The hydrocarbon compound may comprise an aromatic hydrocarbon compound, a saturated or unsaturated aliphatic hydrocarbon compound, and a saturated or unsaturated alicyclic hydrocarbon compound.

In the present disclosure, the “aromatic hydrocarbon compound” means a hydrocarbon compound comprising an aromatic hydrocarbon group. In the present disclosure, the “alicyclic hydrocarbon compound” means a hydrocarbon compound comprising an alicyclic hydrocarbon group.

In the present disclosure, the layer may be referred to as a MXene layer, and the two-dimensional particle may be referred to as a MXene two-dimensional particle or a MXene particle.

In the layer body represented by the MₘXₙ, the layer body may have a crystal lattice in which each X is located in an octahedral array of M.

In addition, the modifier or terminal T may exist on the surface of the layer body represented by the MₘXₙ, and for example, may exist on at least one of two facing surfaces of the layer body. The modifier or terminal T preferably may comprise one or more selected from a hydroxyl group, a fluorine atom, a chlorine atom, an iodine atom, SO₄²⁻and PO₄³⁻, and more preferably may comprise one or more selected from a chlorine atom, an iodine atom, SO₄²⁻and PO₄³⁻.

In the present disclosure, the two-dimensional particle may be understood as a layered material or a layered compound, also represented by “MₘXₙTₛ”, wherein s is any number, and x or z may be conventionally used in place of s. Typically, n may be 1, 2, 3, or 4, but is not limited thereto.

In the above formula of MXene, M is preferably at least one selected from the group consisting of Ti, Zr, Hf, V, Nb, Ta, Cr, Mo, and Mn, more preferably at least one selected from the group consisting of Ti, V, Cr, and Mo, and still more preferably at least one selected from the group consisting of Ti and V.

MXenes in which the above formula: MₘXₙ is expressed as below are known:

Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3C}, Cr_{1.3C}, (Ti, V)₂C, (Ti, Nb)₂C, W₂C, W_{1.3}C, MO₂N, Nb_{1.3C}, Mo_{1.3}Y_{0.6}C (in the above formulae, “1.3” and “0.6” mean about _{1.3} (= 4/3) and about 0.6 (=⅔), respectively),

Ti₃C₂, Ti₃N₂, Ti₃ (CN), Zr₃C₂, (Ti, V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,

Ti₄N₃, V₄C₃, Nb₄C₃, Ta₄C₃, (Ti, Nb)₄C₃, (Nb, Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (MO₂Hf₂)C₃, (Mo₂V₂)C₃, (Mo₂Nb₂)C₃, (MO₂Ta₂)C₃, (W₂Ti₂)C₃, (W₂Zr₂)C₃, (W₂Hf₂)C₃, (MO_{2.7}V_{1.3})C₃(in the above formula, “2.7” and “1.3” mean about 2.7 (= 8/3) and about 1.3 (= 4/3), respectively).

Typically, MₘXₙ is represented by at least one selected from the group consisting of Ti₂C, Ti₃C₂, Ti₃(CN), (Cr₂Ti)C₂, (MO₂Ti)C₂, (MO₂Ti₂)C₃, (MO_{2.7}V_{1.3})C₃, and V₄C₃, and preferably MₘXₙ is represented by at least one selected from the group consisting of Ti₂C, Ti₃C₂, Ti₃(CN), (Cr₂Ti)C₂, (MO₂Ti)C₂, (MO₂Ti₂)C₃, and (Mo_{2.7}V_{1.3})C₃.

Typically in the above formula, M may be titanium or vanadium and X may be a carbon atom or a nitrogen atom. For example, the MAX phase may be Ti₃AlC₂ or V₄AlC₃, the layer body may be Ti₃C₂ or V₄C₃, and MXene may be Ti₃C₂Tₛ or V₄C₃Tₛ (in other words, M is Ti or V, X is C, n is 2 or 3, and m is 3 or 4). In particular, MₘXₙ may be Ti₃C₂ or V₄C₃. In one aspect, the MAX phase may be Ti₃AlC₂, the layer body may be Ti₃C₂, and MXene may be Ti₃C₂Tₛ (in other words, M is TiV, X is C, n is 2, and m is 3). In particular, MₘXₙ may be Ti₃C₂. In another aspect, the MAX phase may be V₄AlC₃, the layer body may be V₄C₃, and MXene may be V₄C₃Tₛ (in other words, M is V, X is C, n is 3, and m is 4). In particular, MₘXₙ may be V₄C₃.

In the present disclosure, MXene may comprise a relatively small amount of A atoms derived from the MAX phase of the precursor, for example, 10 mass % or less with respect to 100 mass % of the total amount of A atoms in the MAX phase of the precursor. The remaining amount of A atoms may be preferably 0 mass % to 8 mass %, and more preferably 0 mass % to 6 mass % with respect to 100 mass % of the total amount of A atoms in the MAX phase of the precursor. However, even if the remaining amount of A atoms exceeds 10 mass %, there may be no problem depending on the application and use conditions of the two-dimensional particle.

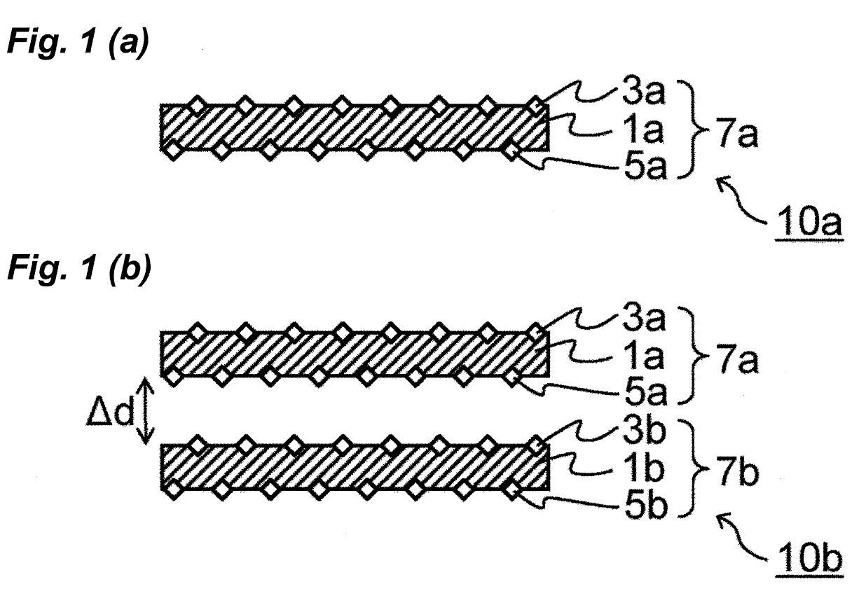

The two-dimensional particle is an aggregate comprising a MXene particle (hereinafter, simply referred to as “MXene particle”) 10a (single-layer MXene particle) of one layer schematically illustrated in FIG. 1(a). More specifically, the MXene particle 10a is an MXene layer 7a having a layer body (MₘXₙ layer) 1a represented by MₘXₙ, and modifiers or terminals T3a and T5a existing on a surface of the layer body 1a (more specifically, on at least one of two facing surfaces of each layer). Therefore, the MXene layer 7a is also represented by “MₘXₙTₛ,” wherein s is any number. In FIG. 1(a), a hydrocarbon compound is not shown.

The two-dimensional particle may comprise one or plural layers. Examples of the MXene particle (multilayer MXene particle) of the plural layers include, but are not limited to, a MXene particle 10b of two layers as schematically shown in FIGS. 1(b). 1b, 3b, 5b, and 7b in FIG. 1(b) are the same as 1a, 3a, 5a, and 7a in FIG. 1(a) described above. In a multilayer MXene particle, two adjacent MXene layers (e.g., 7a and 7b) need not be completely separated from each other, but may be partially in contact with each other. The MXene particle 10a exists as one layer in which the multilayer MXene particle 10b is individually separated, and may be a mixture of the single-layer MXene particle 10a and the multilayer MXene particle 10b in which the unseparated multilayer MXene particle 10b remains. In FIG. 1(b), a hydrocarbon compound is not shown.

Although not limiting the present embodiment, the thickness of each layer in the MXene particle (which corresponds to the MXene layers 7a, 7b) is, for example, not less than 0.8 nm and not more than 5 nm, and particularly 0.8 nm to 3 nm (which may vary mainly depending on the number of M atom layers in each layer). With respect to individual laminates of the multilayer MXene particle that may be comprised, the interlayer distance (alternatively, the void dimension which is indicated by Δd in FIG. 1(b)) may be, for example, 0.8 nm to 10 nm, particularly 0.8 nm to 5 nm, and more particularly 0.8 nm to 1.5 nm. The total number of layers may be 2 to 20,000.

In one aspect, in the two-dimensional particle in the present embodiment, the multilayer MXene particle, which may be contained, comprises a two-dimensional particle having a small number of layers obtained through a delamination treatment. The expression “a small number of layers” means, for example, that the number of stacked layers of MXene layers is 6 or less. In addition, the thickness of the multilayer MXene particle having a small number of layers in the stacking direction is preferably 15 nm or less, and more preferably 10 nm or less. Hereinafter, the “multilayer MXene particle having a small number of layers” may be referred to as “few-layer MXene particle”. The single-layer MXene particle and the few-layer MXene particle may be collectively referred to as “single-layer/few-layer MXene particle”. When a single-layer/few-layer MXene particle is contained, the electrical conductivity of the resulting film may increase.

The two-dimensional particle in the present embodiment preferably comprises a single-layer MXene particle and a few-layer MXene particle, that is, a single-layer/few-layer MXene particle. In the two-dimensional particle of the present embodiment, the proportion of the single-layer/few-layer MXene particle having a thickness of 15 nm or less is preferably 90 vol % or more, and more preferably 95 vol % or more.

In one aspect, the ratio of (the average value of the major axis of the two-dimensional plane of the two-dimensional particle)/(the average value of the thickness of the two-dimensional particle) is, for example, 1.2 or more, preferably 1.5 or more, and more preferably 2 or more. The average value of the major axis of the two-dimensional plane of the two-dimensional particle and the average value of the thickness of the two-dimensional particle may be obtained by a method described later.

### Average Value of Major Axis of Two-Dimensional Plane of Two-Dimensional Particle

In the two-dimensional particle of the present embodiment, the average value of the major axis of the two-dimensional plane is, for example, not less than 1 μm and not more than 20 μm. Hereinafter, the average value of the major axis of the two-dimensional plane may be referred to as “average flake size”.

The larger the average flake size, the larger the electrical conductivity of the film. Since the two-dimensional particle of the present embodiment has a large average flake size of 1.0 μm or more, a film formed using the two-dimensional particle, for example, a film obtained by stacking the two-dimensional particle may achieve an electrical conductivity of 2000 S/cm or more. The average value of the major axis of the two-dimensional plane is preferably 1.5 μm or more, and more preferably 2.5 μm or more. When the delamination treatment of MXene is performed by subjecting MXene to an ultrasonic treatment, most of MXene is reduced in size to about several hundred nanometers in major axis by the ultrasonic treatment, so that the film formed of the single-layer MXene delaminated by the ultrasonic treatment is considered to have a low electrical conductivity.

The average value of the major axis of the two-dimensional plane is, for example, 20 μm or less, preferably 15 μm or less, and more preferably 10 μm or less from the viewpoint of dispersibility in a dispersion medium.

The major axis of the two-dimensional plane refers to a major axis when each MXene particle is approximated to an elliptical shape in an electron micrograph, and the average value of the major axis of the two-dimensional plane refers to a number average of the major axes of 80 particles or more. As the electron microscope, a scanning electron microscope (SEM) or a transmission electron microscope (TEM) photograph may be used.

The average value of the major axis of the two-dimensional particle of the present embodiment may be measured by dissolving a film containing the two-dimensional particle in a solvent and dispersing the two-dimensional particle in the solvent. Alternatively, it may be measured from an SEM image of the film.

### Average Value of Thickness of Two-Dimensional Particle

The average value of the thickness of the two-dimensional particle of the present embodiment is preferably not less than 1 nm and not more than 15 nm. The thickness is preferably 10 nm or less, more preferably 7 nm or less, and still more preferably 5 nm or less. On the other hand, considering the thickness of the single-layer MXene particle, the lower limit of the thickness of the two-dimensional particle may be 1 nm.

The average value of the thickness of the two-dimensional particle is obtained as a number average dimension (for example, a number average of at least 40 particles) based on an atomic force microscope (AFM) photograph or a transmission electron microscope (TEM) photograph.

The two-dimensional particle comprises a hydrocarbon compound. Since the hydrocarbon compound is larger than the interatomic distance of each atom inside the layer body, it is considered that the hydrocarbon compound exists on the layer. As described above, in the present disclosure, the cases where “a hydrocarbon compound exists on a layer” include both the case where the hydrocarbon compound is physically bonded to the layer; and the case where the hydrocarbon compound is not bonded to the layer, and may further include all the case where the hydrocarbon compound is not bonded to the layer; the case where the hydrocarbon compound is in contact with the layer; and the case where the hydrocarbon compound is not in contact with the layer. When the hydrocarbon compound is contained in such forms, oxidation of the layer may be suppressed, which contributes to suppression of a decrease in electrical conductivity, and further to suppression of a decrease in electrical conductivity in a high-temperature environment.

The hydrocarbon compound is typically a compound formed of carbon atoms and hydrogen atoms, and may comprise an aromatic hydrocarbon compound, a saturated or unsaturated aliphatic hydrocarbon compound, and a saturated or unsaturated alicyclic hydrocarbon compound. The hydrocarbon compound preferably comprises one type or two or more types selected from an aromatic hydrocarbon compound and a saturated or unsaturated aliphatic hydrocarbon compound, and more preferably comprises one type or two or more types selected from a saturated or unsaturated aliphatic hydrocarbon compound.

The aromatic hydrocarbon compound may be preferably an aromatic hydrocarbon compound having 6 to 20 carbon atoms, more preferably an aromatic hydrocarbon compound having 6 to 10 carbon atoms, and specific examples thereof include toluene and xylene.

The saturated aliphatic hydrocarbon compound may be preferably a saturated aliphatic hydrocarbon compound having 1 to 20 carbon atoms, more preferably a saturated aliphatic hydrocarbon compound having 4 to 10 carbon atoms, and specific examples thereof include butane, isobutane, 2-methylbutane, 2-methylpentane, 2,4-dimethylpentane, 2-methylheptane, and octane.

The unsaturated aliphatic hydrocarbon compound may be preferably an unsaturated aliphatic hydrocarbon compound having 2 to 20 carbon atoms, more preferably an unsaturated aliphatic hydrocarbon compound having 3 to 10 carbon atoms, and specific examples thereof include propene, isobutene, pentene, 2-methylbutene, 2-methylpentene, 2-methylhexene, and octene.

The saturated or unsaturated alicyclic hydrocarbon compound may be preferably a saturated or unsaturated alicyclic hydrocarbon compound having 3 to 20 carbon atoms, more preferably a saturated or unsaturated alicyclic hydrocarbon compound having 6 to 10 carbon atoms, and specific examples thereof include cyclohexane, methylcyclohexane, cyclohexene, and methylcyclohexene.

The type of hydrocarbon compound in the two-dimensional particle may be specified by gas chromatography-mass spectrometry (GC-MS). A gas chromatography analysis may typically be performed using a gas chromatography-mass spectrometry (GC-MS) apparatus equipped with a pyrolyzer.

The content of carbon atoms derived from the hydrocarbon compound may be preferably 0.5 mass % or more, more preferably 0.5 mass % to 5 mass %, and still more preferably 0.7 mass % to 3 mass % in 100 mass % of the total amount of the two-dimensional particle. When the content of carbon atoms derived from the hydrocarbon compound is in such a range, the electrical conductivity stability may be easily enhanced while maintaining the electrical conductivity.

The content of carbon atoms derived from the hydrocarbon compound may be measured by a carbon-sulfur analysis (CS analysis).

In one aspect, for example, when the MₘXₙ is Ti₃C₂, the content of carbon atoms derived from the hydrocarbon compound may be calculated by subtracting a carbon atomic mass calculated on the assumption that the entire layer (layer body and modifier or terminal T) of the two-dimensional particle is represented by Ti₃C₂O₂ from the total carbon atomic mass measured by a carbon-sulfur analysis (CS analysis).

The interlayer distance in the two-dimensional particle may be preferably 0.8 nm to 1.1 nm. The interlayer distance may be measured as d₀₀₂ by X-ray diffraction measurement (XRD).

### Second Embodiment: Method for Producing Two-Dimensional Particle

Hereinafter, a method for producing a two-dimensional particle in one embodiment of the present disclosure will be described in detail, but the present disclosure is not limited to such an embodiment.

The two-dimensional particle of the present embodiment comprises:
heating a precursor particle in the presence of an organic compound under conditions of an absolute pressure of less than 1,013 hPa and a boiling point of the organic compound or higher to obtain a two-dimensional particle,
wherein the precursor particle comprises one or plural layers,
wherein the one or plural layers comprise a layer body and a modifier or terminal T,
wherein the layer body is represented by a formula below:

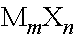

wherein M is at least one metal of Group 3, 4, 5, 6, or 7; X is a carbon atom, a nitrogen atom, or a combination thereof; n is 1 to 4; am is more than n but not more than 5,
wherein the modifier or terminal T (where Tis at least one selected from the group consisting of a hydroxyl group, a fluorine atom, a chlorine atom, an iodine atom, an oxygen atom, a chlorine atom, a phosphorus atom, and a hydrogen atom) exists on a surface of the layer body, and
wherein the organic compound has a melting point of 20° C. or lower.

According to the method for producing a two-dimensional particle of the present disclosure, a two-dimensional particle capable of realizing an electroconductive film having favorable electrical conductivity stability is provided. The present disclosure should not be limited to a specific theory, but the reason the production method of the present disclosure exhibits the above effect is considered as follows.

That is, in the method for producing a two-dimensional particle of the present disclosure, a precursor particle is heated at a temperature equal to or higher than the boiling point of the organic compound in a depressurized state in the coexistence of a liquid organic compound. When heating is performed under such conditions, a hydrocarbon compound is considered to form on the layer in the precursor particle, and the hydrocarbon compound is considered to suppress oxidation of the layer, so that the electrical conductivity stability is improved. Although the reason the hydrocarbon compound is formed is not clear, the layers of MXene are considered to be close to each other, the modifier or terminal T is considered to exist on the surface of the layer, and a space between the MXene layers is considered to be in a highly active state. Hence, the coexistence of the organic compound in this state is considered to promote the formation of the hydrocarbon compound.

The organic compound has a melting point of 20° C. or lower at 1 atm (1,013 hPa). When the melting point of the organic compound is 20° C. or lower, the organic compound may permeate the inside of the precursor particle, and a two-dimensional particle comprising a hydrocarbon compound is easily obtained. The melting point of the organic compound may be preferably 10° C. or lower, more preferably −50° C. to 5° C., and still more preferably—20° C. to 0° C.

The boiling point of the organic compound is, for example, 285° C. or lower, preferably 240° C. or lower, more preferably 200° C. or lower, and is, for example, 50° C. or higher.

The relative permittivity of the organic compound may be preferably 60 or more, more preferably 60 to 300, and still more preferably 60 to 250. When the relative permittivity of the organic compound is in such a range, the hydrocarbon compound may be easily precipitated.

The organic compound may be dissolved or mixed in water. The solubility of the organic compound in water is 5 g/100 g H2O or more, more preferably 10 g/100 g H₂O or more at 25° C. In the present description, the solubility in the case of being mixed in water is treated as infinite.

The organic compound is preferably a highly polar compound. In the present description, the highly polar compound is a concept including not only a compound exhibiting clear charge separation but also a compound having high hydrophilicity. The polarity of the compound may be evaluated using a dissolution parameter as an index. The Hildebrand solubility parameter (also referred to as “SP value”) of the organic compound is 19.0 MPa^{1/2} or more. The SP value of the organic compound is preferably equal to or less than the SP value of water, and is 47.8 MPa^{1/2} or less. The SP value is a value serving as an index of the polarity of the compound, and the larger the SP value, the higher the polarity, and compounds with similar SP values tend to be compatible with each other.

The molecular weight of the organic compound is, for example, 500 or less, preferably 300 or less, more preferably 200 or less, and is, for example, 30 or more.

Examples of the organic compound include organic compounds having one or more of a carbonyl group, an ester group, an amide group, a formamide group, a carbamoyl group, a carbonate group, an aldehyde group, an ether group, a sulfonyl group, a sulfinyl group, a hydroxyl group, a cyano group, and a nitro group, and preferably an organic compound having an amide group is exemplified. Specific examples of the organic compound include alcohols such as methanol (MeOH), ethanol (EtOH), and 2-propanol; sulfone compounds such as sulfolane; sulfoxides such as dimethyl sulfoxide (DMSO); carbonates such as propylene carbonate (PC); amides such as N-methylformamide (NMF), N,N-dimethylformamide, N-methylpyrrolidone (NMP), and dimethylacetamide (DMAc); ketones such as acetone and methyl ethyl ketone (MEK); and tetrahydrofuran (THF), and preferably an amide is exemplified.

The pressure during the heating is less than 1,013 hPa, preferably 1,000 hPa or less, more preferably 50 hPa to 1,000 hPa, and still more preferably 100 hPa to 1,000 hPa as an absolute pressure. When the pressure is in such a range, the layer of MXene may be maintained, and a hydrocarbon compound is easily formed.

The temperature during the heating is equal to or higher than the boiling point of the organic compound, and is preferably 200° C. or higher, more preferably not lower than 200° C. to 400° C., and still more preferably 200°° C. to 350° C. When the temperature is in such a range, the layer structure of MXene may be maintained, and a hydrocarbon compound is easily formed.

The heating time is preferably 1 to 30 hours, and more preferably 5 to 20 hours.

Pre-drying may be performed before the heating. Such pre-drying may be performed at 80° C. or lower under normal pressure. The pressure during the pre-drying may be preferably 900 hPa to 1,200 hPa as an absolute pressure, and may be 950 hPa to 1,160 hPa as an absolute pressure. The temperature during the pre-drying may be 10° C. or lower, preferably 10° C. to 80° C., more preferably 20° C. to 70° C., and still more preferably 30° C. to 70° C. The pre-drying time is, for example, 30 minutes to 10 hours, and preferably 1 hour to 5 hours.

The amount of the organic compound may be preferably 5 to 100 parts by mass, and more preferably 10 to 99 parts by mass with respect to 1 part by mass of the precursor particle, but is not limited thereto.

The precursor particle may be typically produced by a production method comprising:
(a) preparing a predetermined precursor;
(b) removing at least some A atoms from the precursor using an etching liquid to obtain an etched material;
(c) washing the etched material to obtain an etched washed material;
(d) mixing the etched washed material with an intercalator to obtain an intercalated material; and
(e) stirring the intercalated material to obtain a delaminated material comprising a precursor particle, but is not limited to such an aspect.

The method of allowing the precursor particle and the organic compound to coexist is not particularly limited. Such a method may be carried out, for example, by one or more operations selected from the following (d1), (f), and (g):
(d1) using an organic compound as the intercalator;
(f) mixing the delaminated material and the organic compound; or
(g) drying the delaminated material and then mixing with an organic compound, but is not limited thereto.

Hereinafter, each step will be described in detail.

### Step (a)

First, a predetermined precursor is prepared. The predetermined precursor usable in the present embodiment is a MAX phase that is a precursor of MXene, and is represented by a formula below:

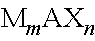

wherein M is at least one metal of Group 3, 4, 5, 6, or 7, and comprises at least Ti,
X is a carbon atom, a nitrogen atom, or a combination thereof,
A is at least one element of Group 12, 13, 14, 15, or 16,
n is not less than 1 and not more than 4, and
m is more than n but not more than 5.

The M, X, n, and m are as described above.

A is at least one element of Group 12, 13, 14, 15, or 16, normally an element of Group A, typically of Group IIIA and Group IVA, and more specifically may comprise at least one selected from the group consisting of Al, Ga, In, Tl, Si, Ge, Sn, Pb, P, As, S, and Cd, and is preferably Al.

The MAX phase has a crystal structure in which a layer formed of A atoms is located between two layers represented by MₘXₙ. The two layers represented by MₘXₙ may have a crystal lattice in which each X is located in an octahedral array of M. When typically m=n +1, the MAX phase comprises repeating units in which each one layer of X atoms is disposed in between adjacent layers of n+1 layers of M atoms (these are also collectively referred to as “MₘXₙ layer”), and a layer of A atoms (“A atom layer”) is disposed as a layer next to the (n+1)th layer of M atoms, but not limited thereto.

The MAX phase may be produced by a known method. For example, TiC powder, Ti powder, and Al powder are mixed in a ball mill, and the resulting mixed powder is fired in an Ar atmosphere to obtain a fired body (block-shaped MAX phase). Thereafter, the fired body obtained is pulverized by an end mill, so that a powdery MAX phase for the next step may be obtained.

### Step (b)

In the step (b), an etching treatment for removing at least some A atoms from MₘAXₙ of the precursor by etching is performed using an etching liquid. As a result, a treated material in which at least a part of the layer formed of A atoms is removed while maintaining the layer represented by MₘXₙ in the precursor is obtained.

The etching liquid may contain an acid such as HF, HCl, HBr, HI, sulfuric acid, phosphoric acid, or nitric acid, and typically, an etching liquid comprising an F atom may be used. Examples of the etching liquid include a mixed liquid of LiF and hydrochloric acid; a mixed liquid of hydrofluoric acid and hydrochloric acid; and a mixed liquid comprising hydrofluoric acid, and these mixed liquids may further comprise phosphoric acid or the like. The etching liquid may be typically an aqueous solution.

As the etching operation using the etching liquid and other conditions, conventionally performed conditions may be adopted.

### Step (c)

In the step (c), the etched material obtained by the etching treatment is washed to obtain an etched washed material. By performing the washing, the acid and the like used in the etching treatment may be sufficiently removed.

The washing may be performed using a washing liquid, and typically, may be performed by mixing the etched material and a washing liquid. Such a washing liquid typically comprises water, and pure water is preferable. On the other hand, a small amount of hydrochloric acid or the like may be further contained in addition to pure water. The amount of the washing liquid to be mixed with the etched material and the method of mixing the etched material and the washing liquid are not particularly limited. Examples of such a mixing method comprise a method in which the etched material and the washing liquid are allowed to coexist, and stirring, centrifugation, and the like are performed. Examples of the stirring method include a stirring method using hand shaking, an automatic shaker, a share mixer, a pot mill, or the like. The degree of stirring such as a stirring speed and a stirring time may be adjusted according to the amount, concentration, and the like of the etched material to be treated. The washing with the washing liquid may be performed one or more times, and it is preferable to perform the washing multiple times. For example, specifically, the washing with the washing liquid may be performed by sequentially performing step (i) adding the washing liquid (to the treated material or the remaining precipitate obtained in the following (iii)) and stirring, step (ii) centrifuging the stirred material, and step (iii) discarding the supernatant after centrifugation, and the steps (i) to (iii) are repeated within a range of two or more times, and for example, 15 times or less.

### Step (d)

In the step (d), an intercalation treatment is performed using an intercalator to obtain an intercalated material.

Examples of the intercalator include a metal compound comprising a metal cation, the organic compound, and an organic salt.

The metal cation may be the same as the metal cation in the two-dimensional particle.

Examples of the metal compound include an ionic compound in which the metal cation and an anion are bonded. For example, an iodide, a phosphate, a sulfide salt comprising a sulfate, a nitrate, an acetate, and a carboxylate of the above metal cations are exemplified. As the metal cation, an alkali metal ion and an alkaline earth metal cation are preferable, and a lithium ion is more preferable. As the metal compound, a metal compound comprising an alkali metal ion or an alkaline earth metal ion is preferable, a metal compound comprising a lithium ion is more preferable, an ionic compound of a lithium ion is still more preferable, and one or more of an iodide, a phosphate, and a sulfide salt of a lithium ion is particularly preferable. When a lithium ion is used as the metal ion, it is considered that water hydrated to the lithium ion has the most negative permittivity, and thus it is easy to form a single layer.

When a metal compound comprising a metal cation is used as the intercalator, the metal cation may be intercalated into the etched washed material. As a result, an intercalated material in which the metal cation is intercalated between two adjacent MₘXₙ layers is obtained.

The organic compound has the same meaning as the organic compound allowed to coexist when the precursor particle is heated.

When an organic compound is used as the intercalator, the organic compound is intercalated into the etched washed material. As a result, an intercalated material in which the organic compound is intercalated between two adjacent MₘXₙ layers is obtained.

Examples of the organic salt include organic salts comprising an organic cation and an anion. Examples of the organic cation include an ammonium cation, and examples of the anion include a hydroxide ion and a chloride ion. Examples of the organic salt include an ammonium salt. Specific examples of the organic salt include tetramethylammonium hydroxide (TMAOH), tetraethylammonium hydroxide (TEAOH), and tetrabutylammonium chloride.

When an organic salt is used as the intercalator, an organic cation constituting the organic salt may be intercalated into the etched washed material. As a result, an intercalated material in which the organic cation is intercalated between two adjacent MₘXₙ layers is obtained.

Such an intercalation treatment may be performed in a dispersion medium. A specific method of the intercalation treatment is not particularly limited, and for example, the etched washed material and the metal compound are mixed, and may be stirred or may be left to stand. For example, stirring at room temperature may be exemplified. Examples of the stirring method include a method using a stirring bar such as a stirrer, a method using a stirring blade, a method using a mixer, and a method using a centrifugal device, and the stirring time may be set according to the production scale of the single-layer/few-layer MXene particle, and may be set, for example, for 12 to 24 hours.

The intercalation treatment may be performed in the presence of a dispersion medium. Examples of the dispersion medium include water; and organic media such as N-methylpyrrolidone, N-methylformamide, N,N-dimethylformamide, methanol, ethanol, dimethyl sulfoxide, ethylene glycol, and acetic acid.

The order of mixing the dispersion medium, the etched washed material, and the metal compound is not particularly limited, but in one aspect, the metal compound may be mixed after mixing the dispersion medium and the etched washed material. Typically, the etching liquid after the etching treatment may be used as the dispersion medium.

The intercalation treatment may be typically performed for the etched washed material, but may be performed simultaneously with the etching treatment for the precursor in another aspect. Specifically, such etching and intercalation treatments comprise mixing a precursor, an etching liquid, and a metal compound comprising a metal cation to remove at least some A atoms from the precursor, and intercalating the metal cation into the precursor from which the A atoms have been removed to obtain an intercalated material. As a result, at least some A atoms are removed from the precursor (MAX), and the MₘXₙ layer in the precursor remains, and an intercalated material in which the metal cation is intercalated between the plurality of adjacent MₘXₙ layers is obtained.

As the etching liquid and the metal compound used in the etching and intercalation treatments, similar ones to the etching liquid and the metal compound used in the step (b) may be used, respectively.

### Step (d1)

In the step (d), use of the organic compound as the intercalator allows the resulting precursor particle to coexist with the organic compound. The step (d1) may be performed in the same manner as the step (d) except that the organic compound is used as the intercalator.

### Step (e)

In the step (e), the intercalated material is stirred, and a delamination treatment for delaminating the intercalated material is performed to obtain a delaminated material. By such stirring, a shear stress is applied to the intercalated material, at least a part between two adjacent MₘXₙ layers may be peeled, and the MXene particle may be formed into a single layer or few layers.

Conditions for the delamination treatment are not particularly limited, and the delamination treatment may be performed by a known method. For example, as a method of applying a shear stress to the intercalated material, a method in which the intercalated material is dispersed in a dispersion medium, followed by stirring may be exemplified. Examples of the stirring method include stirring using a mechanical shaker, a vortex mixer, a homogenizer, an ultrasonic treatment, hand shaking, an automatic shaker, or the like. The degree of stirring such as a stirring speed and a stirring time may be adjusted according to the amount, concentration, and the like of the treated material to be treated. For example, the slurry after the intercalation is centrifuged to discard the supernatant, then pure water is added to the remaining precipitate, and the mixture is stirred by, for example, hand shaking or an automatic shaker to perform layer separation (delamination). The removal of the unpeeled material comprises a step of performing centrifugation to discard the supernatant, and then washing the remaining precipitate with water. For example, (i) pure water is added to the remaining precipitate after discarding the supernatant and stirred, (ii) centrifugation is performed, and (iii) the supernatant is recovered. This operation of (i) to (iii) is performed one or more times, preferably not less than two times and not more than 10 times, and a supernatant comprising the single-layer/few-layer MXene particle is obtained as the delaminated material. Alternatively, a clay comprising the single-layer/few-layer MXene particle may be obtained as a delaminated material by centrifuging the supernatant, and discarding the supernatant after centrifugation.

The delaminated material may be further washed before being subjected to the next step.

In one aspect, the washing may be performed using a washing liquid, and typically, may be performed by mixing the delaminated material and a washing liquid. In another aspect, the washing may be performed by acid-treating the delaminated material and then mixing the acid-treated material with a washing liquid. As of the acid used for the acid treatment, an inorganic acid such as hydrochloric acid, sulfuric acid, nitric acid, phosphoric acid, perchloric acid, hydroiodic acid, hydrobromic acid, or hydrofluoric acid, an organic acid such as acetic acid, citric acid, oxalic acid, benzoic acid, or sorbic acid may be appropriately used, and the concentration of the acid in the acid solution may be appropriately adjusted according to the delaminated material. Further, the washing with the washing liquid may be performed by sequentially performing step (i) adding the washing liquid (to the treated material or the remaining precipitate obtained in the following (iii)) and stirring, step (ii) centrifuging the stirred material, and step (iii) discarding the supernatant after centrifugation, and the steps (i) to (iii) are repeated within a range of two or more times, and for example, 15 times or less. The stirring may be performed using hand shaking, an automatic shaker, a share mixer, a pot mill, or the like. The acid treatment may be performed one or more times, and the operation of mixing with a fresh acid solution (an acid solution not used for the acid treatment) and stirring the mixture may be performed within a range of two or more times, and for example, 10 times or less as necessary. As the washing liquid, a similar one to the washing liquid in the step (c) may be used, and for example, specifically, water may be used as the washing liquid, and pure water is preferable. The mixing may be performed by a method similar to the mixing method in the step (c), and specific examples thereof include stirring and centrifugation. Examples of the stirring method include a stirring method using hand shaking, an automatic shaker, a share mixer, a pot mill, or the like.

### Step (f)

In the step (f), the delaminated material and the organic compound are mixed. Thereby, the organic compound may be inserted between the layers. In the step (f), mixing of the delaminated material and the organic compound means that the delaminated material and the organic compound are mixed to a state where the organic compound may exist in the delaminated material from a state where the delaminated material and the organic compound are completely separated.

The method of mixing the delaminated material and the organic compound is not particularly limited, and may be performed by a known method. Examples thereof include a method in which the organic compound and the delaminated material are stirred and dispersed. Examples of the stirring method include stirring using a mechanical shaker, a vortex mixer, a homogenizer, an ultrasonic treatment, hand shaking, an automatic shaker, or the like. The degree of stirring such as a stirring speed and a stirring time may be adjusted according to the amount, concentration, and the like of the treated material to be treated. In one aspect, the content of the delaminated material in the mixture comprising the delaminated material and the organic compound may be, for example, 0.5 mass % to 10 mass %, and further 1 mass % to 5 mass %.

When the delaminated material and the organic compound are mixed, another dispersion medium may coexist. Specific examples of the another dispersion medium include water. The organic compound and another dispersion medium may be mixed so that the volume ratio of the organic compound and the another dispersion medium (organic compound/another dispersion medium) is, for example, 50/50 or more, preferably 55/45 or more.

When the delaminated material and the organic compound are mixed, a resin may be further mixed as necessary. As a result, an electroconductive film comprising the two-dimensional particle and the resin is obtained.

### Step (g)

In the step (g), the delaminated material is dried and then mixed with the organic compound. By drying the delaminated material, moisture in the delaminated material may be removed. Hereinafter, a material obtained by subjecting the delaminated material to a drying treatment is also referred to as a dried material.

The drying method may be performed under mild conditions such as natural drying (typically, placement in an air atmosphere at normal temperature and normal pressure) and air drying (blowing air), or may be performed under relatively active conditions such as hot air drying (blowing heated air), heat drying, vacuum drying, and/or freeze drying. In the step (g), it is preferable to remove water in the delaminated material as much as possible, and from this viewpoint, it is preferable to perform drying under active conditions. In the step (g), it is preferable to remove water without heating to a high temperature. For example, the drying temperature in the step (g) may be preferably 190° C. or lower, more preferably 150° C. or lower, further 140° C. or lower, and particularly 120° C. or lower. In one aspect, the temperature may be lower than 20° C., and even 10° C. or lower. From this viewpoint, the drying method is preferably vacuum drying and/or freeze drying, and more preferably freeze drying.

In the drying in this step, the dispersion medium may be removed from the delaminated material, and a film-like dry material is typically obtained.

The mixing of the dried material and the organic compound may be performed by any method, and may be performed, for example, by allowing the organic compound to permeate the dried material or immersing the dried material in the organic compound.

In such an aspect, the amount of the dried material may be, for example, not less than 0.5 parts by mass and not more than 10 parts by mass, and further not less than 1 part by mass and not more than 5 parts by mass with respect to 100 parts by mass of the organic compound.

### Third Embodiment: Electroconductive Film

Hereinafter, an electroconductive film in one embodiment of the present disclosure will be described in detail, but the present disclosure is not limited to such an embodiment.

The electroconductive film of the present embodiment comprises the two-dimensional particle, and has an electrical conductivity of 2,000 S/cm or more.

Thereby, an electroconductive film having favorable electrical conductivity stability may be provided. The present disclosure should not be construed as being limited to a specific theory, but the reason why the electroconductive film of the present disclosure may exhibit such an effect is considered as follows. That is, the electroconductive film of the present disclosure comprises the two-dimensional particle, and in the two-dimensional particle, a hydrocarbon compound exists on the MXene layer. Therefore, it is considered that oxidation of the MXene layer may be suppressed even in a high-temperature environment, and an electroconductive film having favorable electrical conductivity stability, particularly favorable electrical conductivity stability even in a high-temperature environment may be provided.

The electrical conductivity of the electroconductive film is preferably 2,000 S/cm or more, more preferably 5,000 S/cm or more, still more preferably 7,000 S/cm or more, and may be usually 25,000 S/cm or less.

In a case where the electroconductive film is subjected to X-ray photoelectron spectroscopy (XPS) analysis, the ratio of the area of the peaks attributed to divalent and trivalent Ti to the total area of the peaks attributed to Ti2p (hereinafter, also referred to as “Ti2p area ratio”) may be preferably 80% to 100%, more preferably 85% to 100%, and still more preferably 90% to 100%. The larger the Ti2p area ratio, the more the oxidation of the MXene layer surface is suppressed, and the electrical conductivity stability may be favorable. As the oxidation progresses, the peak area attributed to tetravalent Ti increases, and the Ti2p area ratio decreases.

When the electroconductive film is subjected to a heat treatment at 300° C. for 2 hours under normal pressure, the ratio A₁/A₀ of A₁ to A₀ may be preferably 80% to 100%, more preferably 85% to 100%, and still more preferably 90% to 100%, where the Ti2p area ratio before the heat treatment is denoted by A₀, and the Ti2p area ratio after the heat treatment is denoted by A₁. When the ratio A₁/A₀ is in such a range, oxidation of the MXene layer surface is suppressed, and the electrical conductivity stability may be favorable.

The content of the two-dimensional particle in the electroconductive film may be preferably 70 vol % to 100 vol %, more preferably 90 vol % to 100 vol %, and still more preferably 95 vol % to 100 vol %.

The electroconductive film may further comprise a resin in addition to the two-dimensional particle. As such a resin, one type or two or more types selected from a thermosetting resin, a thermoplastic resin, and an electroconductive polymer may be used.

Examples of the thermosetting resin include an epoxy resin, an epoxy acrylate resin, a phenol novolak-type epoxy resin, a phenol resin, a urethane resin, a silicone resin, a polyamide resin, a polyimide resin, a polyamideimide resin, and a fat. As the thermosetting resin, one type may be used alone, or two or more types may be used in combination.

Examples of the thermoplastic resin include polyolefin resins (for example, a polyethylene resin and a polypropylene resin), polyvinyl chloride, a polystyrene resin, polyvinyl acetate, an acrylic resin, a polyester resin, polylactic acid, a polyurethane resin, a polycarbonate resin, a polyvinyl acetal resin, a polyvinyl butyral resin, a fluorine-based resin, a liquid crystal polymer, a polyacrylic acid, a polyether resin, a polyphenyl sulfide resin, a diallyl phthalate resin, a polyvinyl alcohol resin (for example, a cationically modified polyvinyl alcohol), an epoxy resin without adding a curing agent, and a phenoxy resin without adding a curing agent. As the thermoplastic resin, one type may be used alone, or two or more types may be used in combination.

Examples of the electroconductive polymer include poly(3,4-ethylenedioxythiophene):polystyrene sulfonic acid (PEDOT:PSS), polyaniline, polypyrrole, and polythiophene. As the electroconductive polymer, one type may be used alone, or two or more types may be used in combination.

As the resin, a polyurethane resin, a polyacrylic acid, and poly(3,4-ethylenedioxythiophene):polystyrene sulfonic acid (PEDOT:PSS) are preferable.

The film may further comprise another additive.

The method for producing an electroconductive film in the present embodiment comprises forming an electroconductive film using the two-dimensional particle, and in one aspect, the method comprises heating a precursor film comprising a precursor particle under the conditions of an absolute pressure of less than 1,013 hPa and a boiling point of the organic compound or higher in the presence of an organic compound to obtain an electroconductive film. As a result, a hydrocarbon compound is formed on the MXene layer, and oxidation of the MXene layer is suppressed, so that an electroconductive film having favorable electrical conductivity stability is obtained.

The pressure during the heating is less than 1,013 hPa, preferably 1,000 hPa or less, more preferably 50 hPa to 1,000 hPa, and still more preferably 100 hPa to 1,000 hPa as an absolute pressure. It is considered that when the pressure is in such a range, the layer of MXene may be maintained, and a hydrocarbon compound is easily formed.

The temperature during the heating is equal to or higher than the boiling point of the organic compound, and is preferably 200° C. or higher, more preferably 200° C. to 400° C., and still more preferably 200° C. to 350° C. When the temperature is in such a range, the layer structure of MXene may be maintained, and a hydrocarbon compound is easily formed.

The heating time is preferably 1 to 30 hours, and more preferably 5 to 20 hours.

Pre-drying may be performed before the heating. Such pre-drying may be performed at 80° C. or lower under normal pressure. The pressure during the pre-drying may be preferably 900 hPa to 1,200 hPa as an absolute pressure, and may be 950 hPa to 1,160 hPa as an absolute pressure. The temperature during the pre-drying may be 10° C. or lower, preferably 10° C. to 80° C., more preferably 20° C. to 70° C., and still more preferably 30° C. to 70° C. The pre-drying time is, for example, 30 minutes to 10 hours, and preferably 1 hour to 5 hours.

The precursor film may be produced by one selected from the following step (h) or (f1):
(h) forming a precursor film using a mixed liquid comprising the precursor particle and the organic compound; or
(f1) forming a dry film using a dispersion comprising the precursor particle, and allowing the organic compound to permeate the dry film.

Each step will be described below.

### Step (h)

As the mixed liquid comprising the precursor particle and the organic compound, a mixture of the delaminated material obtained in the step (f) and the organic compound may be used as it is, or a mixed liquid obtained by mixing the precursor particle that may be produced by any method and the organic compound may be used.

In the mixed liquid, the content of the precursor particle may be, for example, 0.5 mass % to 10 mass %, and further 1 mass % to 5 mass % in 100 mass % of the total amount of the mixed liquid.

The mixed liquid may comprise another dispersion medium in addition to the organic compound. Specific examples of the another dispersion medium include water. The organic compound and another dispersion medium may be mixed so that the volume ratio of the organic compound and the another dispersion medium (organic compound/another dispersion medium) is, for example, 50/50 or more, preferably 55/45 or more.

The mixed liquid may further comprise the resin as necessary.

The formation of the precursor film may be performed by, for example, subjecting the mixed liquid to suction filtration, or applying the mixed liquid and drying the applied mixed liquid under normal pressure once or twice or more.

Examples of the method of applying the mixed liquid include a method of applying the mixed liquid by spraying. The spraying method may be, for example, an airless spraying method or an air spraying method, and specific examples thereof include a method of spraying using a nozzle such as a one-fluid nozzle, a two-fluid nozzle, or an air brush.

### Step (f1)

As the dispersion comprising the precursor particle, the delaminated material obtained in the step (f) may be used as it is, or a dispersion in which the precursor particle that may be produced by any method is dispersed in a dispersion medium may be used.

Examples of the dispersion medium include water; and organic media such as N-methylpyrrolidone, N-methylformamide, N,N-dimethylformamide, methanol, ethanol, dimethyl sulfoxide, ethylene glycol, and acetic acid.

The content of the precursor particle may be, for example, 0.5 mass % to 10 mass %, and further 1 mass % to 5 mass % in 100 mass % of the total amount of the dispersion.

The formation of the dry film may be performed by subjecting the dispersion to suction filtration, or applying the dispersion and drying the dispersion under normal pressure once or twice or more. Examples of the method of applying the dispersion include a method of applying the dispersion by spraying. The spraying method may be, for example, an airless spraying method or an air spraying method, and specific examples thereof include a method of spraying using a nozzle such as a one-fluid nozzle, a two-fluid nozzle, or an air brush.

The permeation of the organic compound into the dry film may be typically performed by immersing the dry film in the organic compound, or the like.

Examples of the application using the film of the present embodiment include an electrode. The electrode is not limited to a specific form as long as the electrode comprises the electroconductive film. Examples of the electrode include an electrode in a solid state and an electrode in a flexible and soft state.

In the electrode of the present embodiment, the film may be exposed to the outside air so as to be in direct contact with the object to be measured, or may be covered with a substrate and/or a protective film or the like.

When the electrode of the present embodiment has a substrate, the film and the substrate may be in direct contact with each other. The material of the substrate is not particularly limited, and may be, for example, an inorganic material such as ceramic or glass, or an organic material. Examples of the organic material include a flexible organic material, and specific examples thereof include a thermoplastic polyurethane elastomer (TPU), a PET film, and a polyimide film. The material of the substrate may be a fiber material (for example, a sheet-shaped fiber material) such as paper or cloth.

The protective layer may be a layer covering at least a part or all of the film, and preferably may be a layer covering at least a part of the film. The protective layer may be an organic material, and specifically may be a resin such as an acrylic resin, a polyester resin, a polyamide resin, a polyimide resin, a polyamideimide resin, a polyolefin resin, a polycarbonate resin, a polyurethane resin, a polystyrene resin, a polyether resin, polylactic acid, or polyvinyl alcohol.

The electrode may be utilized for any suitable application. Examples thereof include a counter electrode and a reference electrode in electrochemical measurement, an electrochemical capacitor electrode, a battery electrode, a bioelectrode, a sensor electrode, an antenna electrode, and an electrical stimulation electrode. It can also be used in applications that require maintaining a high electrical conductivity (reducing a decrease in initial electrical conductivity and preventing oxidation), such as an electromagnetic shield (EMI shield). Details of these applications will be described below.

The electrode is not particularly limited, and may be, for example, a capacitor electrode, a battery electrode, a biosignal sensing electrode, a sensor electrode, an antenna electrode, an electrical stimulation electrode, or the like. Use of the above film may provide a large-capacity capacitor and battery, a low-impedance biosignal sensing electrode, a highly sensitive sensor, and an antenna even with a smaller volume (device-occupied volume).

The capacitor may be an electrochemical capacitor. The electrochemical capacitor is a capacitor utilizing capacitance developed due to a physicochemical reaction between an electrode (electrode active material) and ions (electrolyte ions) in an electrolytic solution, and may be used as a device (power storage device) that stores electric energy. The battery may be a repeatedly chargeable and dischargeable chemical battery. The battery may be, for example, a lithium ion battery, a magnesium ion battery, a lithium sulfur battery, a sodium ion battery, or the like, but not limited thereto.

The biosignal sensing electrode is an electrode for acquiring a biosignal. The biosignal sensing electrode may be, for example, an electrode for measuring EEG (electroencephalogram), ECG (electrocardiogram), EMG (electromyogram), or EIT (electrical impedance tomography), but not limited thereto.

The sensor electrode is an electrode for detecting a target substance, a state, abnormality, or the like. The sensor may be, for example, a gas sensor, a biosensor (a chemical sensor utilizing a bio-originated molecular recognition mechanism), or the like, but not limited thereto.

The antenna electrode is an electrode for emitting an electromagnetic wave into space and/or receiving an electromagnetic wave in space. The antenna formed by the antenna electrode is not particularly limited, and examples thereof include antennas for mobile communications such as mobile phones (so-called 3G, 4G, and 5G antennas), RFID antennas, and near field communication (NFC) antennas.

The electrical stimulation electrode is an electrode for applying an electrical stimulation to a living body. Such electrical stimulation may be applied to a living body, particularly a biological tissue, for example, a spinal cord, a brain, a nerve tissue, a muscle tissue, or the like, but is not limited thereto.

The two-dimensional particle, the method for producing the same, and the electroconductive film in one embodiment of the present disclosure have been described in detail above, but various modifications may be made. The two-dimensional particle and the electroconductive film of the present disclosure may be produced by methods different from the production methods in the above embodiments. It should be noted that the methods for producing the two-dimensional particle and the electroconductive film of the present disclosure are not limited only to those that provide the two-dimensional particle and the electroconductive film in the above embodiments.

### EXAMPLES

The present disclosure will be described more specifically with reference to the following examples, but the present disclosure is not limited thereto.

### Example 1

### Fabrication of Two-Dimensional Particle

In Example 1, an electroconductive film comprising a two-dimensional particle was fabricated by sequentially performing (1) preparation of a precursor (MAX), (2) etching of the precursor, (3) washing, (4) intercalation, (5) delamination and washing, (6) mixing with N-methylformamide, and (7) preparation and heating of a precursor film described in detail below.

### (1) Preparation of Precursor (MAX)

TiC powder, Ti powder, and Al powder (all manufactured by Kojundo Chemical Laboratory Co., Ltd.) were placed in a ball mill comprising zirconia balls at a molar ratio of 2:1:1 and mixed for 24 hours. The obtained mixed powder was fired in an Ar atmosphere at 1350° C. for 2 hours. The fired body (block) thus obtained was crushed with an end mill to a maximum size of 40 μm or less. Thereby, a Ti₃AlC₂ particle was obtained as the MAX particle.

### (2) Etching of Precursor (ACID Method)

A solid-liquid mixture (slurry) comprising a solid component derived from the Ti₃AlC₂ powder was obtained by performing etching under the following etching conditions using the Ti₃AlC₂ particle (powder) prepared by the above method.

### Etching Conditions

Precursor: Ti₃AlC₂ (Sieving with 45 μm mesh)
Etching liquid formulation: 49% HF 6 mL
H₂O 18 mL
HCl (12M) 36 mL
Precursor charge amount: 3.0 g
Etching vessel: 100 mL Eye Boy
Etching temperature: 35° C.
Etching time: 24 h
Stirrer rotation speed: 400 rpm

### (3) Washing

The slurry was equally divided into two portions and inserted into two 50 mL centrifuge tubes, and centrifugation was performed under the condition of 3500G using a centrifuge, and then the supernatant was discarded. An operation of adding 40 mL of pure water to the remaining precipitate in each centrifuge tube, performing centrifugation again at 3500G, and separating and removing the supernatant was repeated 11 times. After final centrifugation, the supernatant was discarded to obtain a Ti₃C₂Tx-water medium clay.

### (4) Intercalation

The clay of Ti₃C₂Tₛ and a water medium was stirred at 20° C. to 25° C. for 12 hours using LiCl as a Li-containing compound according to the following conditions to perform Li intercalation.

### Conditions for Li Intercalation

Ti₃C₂Tx-water medium clay (MXene after washing): Solid content: 0.75 g
LiCl: 0.75 g
Pure water: 37.2 g
Intercalation vessel: 100 mL Eye Boy
Temperature: 20° C. to 25° C. (room temperature)
Time: 10 h
Stirrer rotation speed: 800 rpm

### (5) Delamination and Washing

(i) To the Ti₃C₂ Tx-water medium clay, 40 mL of pure water was added, then the mixture was stirred with a shaker for 15 minutes, (ii) the mixture was centrifuged at 3,500G, and (iii) the supernatant was recovered as a single-layer MXene-containing liquid. The operations (i) to (iii) were repeated four times in total to obtain a single-layer MXene-containing supernatant. Further, this supernatant was centrifuged under the conditions of 4,300G and 2 hours using a centrifuge, and then the supernatant was discarded to obtain a clay comprising a delaminated material.

### (6) Mixing With N-methylformamide

A mixed dispersion medium was obtained by mixing 55 parts by volume of N-methylformamide and 45 parts by volume of water, and the delaminated material and the mixed dispersion medium were mixed so that the content of the delaminated material in the mixture after mixing was 1.5 mass %. Thereafter, this mixture was dispersed for 15 minutes using an ultrasonic cleaner (AS482 manufactured by AS ONE Corporation) to obtain a slurry comprising a two-dimensional particle.

### (7) Preparation and Heating of Precursor Film

The slurry comprising the two-dimensional particle was taken in a predetermined amount in a 50 mL centrifuge tube, and pure water was added thereto. At this time, the amount of pure water added was adjusted so that the concentration of the delaminated material in the mixture was 1.5 mass %. Thereafter, the mixture was stirred for 15 minutes by a shaker to obtain a slurry.

The slurry was subjected to suction filtration to fabricate a filtration film. As a filter for suction filtration, a membrane filter (Durapore, manufactured by Merck Corporation, pore size 0.45 μm) was used. The filtration film was dried at 150° C. for 16 hours using a vacuum oven to prepare a precursor film.

The obtained precursor film was placed in a vacuum oven and heated under the conditions of an absolute pressure of 912 hPa (gauge pressure of −0.1 MPa) and 200° C. for 12 hours to prepare a film.

### EXAMPLE 2

### Fabrication of Two-Dimensional Particle

In Example 2, a two-dimensional particle-containing composition (MXene-containing composition) was fabricated by sequentially performing (1) preparation of a precursor (MAX), (2) etching of the precursor and Li intercalation, (3) water washing, (4) intercalation of a high relative permittivity dispersion medium (N-methylformamide), and (5) delamination described in detail below.

### (1) Preparation of Precursor (MAX)

VC powder, V powder, and Al powder (all manufactured by Kojundo Chemical Laboratory Co., Ltd.) were placed in a ball mill containing zirconia balls at a molar ratio of 3:1:1 and mixed for 24 hours. The obtained mixed powder was fired in an Ar atmosphere at 1600° C. for 2 hours. The fired body (block-shaped MAX) thus obtained was crushed with an end mill to a maximum size of 40 μm or less. In this way, a V₄AlC₃ particle was obtained as a precursor (powdery MAX).

### (2) Etching of precursor and Li Intercalation

A solid-liquid mixture (slurry) comprising a solid component derived from the V₄AlC₃ powder was obtained by performing etching under the following etching conditions using the V₄AlC₃ particle (powder) prepared by the above method.

### Etching Conditions

Precursor: V₄AlC₃ (Sieving with 45 μm mesh)
Etching liquid formulation: 49% HF 60 mL
Metal salt: LiCl 3 g
Precursor charge amount: 3.0 g
Reaction vessel: 100 mL Eye Boy
Etching temperature: 50° C.
Etching time: 48 h
Stirrer rotation speed: 400 rpm

### (3) Water Washing

The slurry was equally divided into two portions and inserted into two 50 mL centrifuge tubes. Then, centrifugation was performed under the conditions of 3500G and 5 minutes using a centrifuge, and then the supernatant was discarded. Thereafter, (i) 35 mL of pure water was added to the remaining precipitate in each centrifuge tube, (ii) the mixture was stirred by hand shaking, (iii) the mixture was centrifuged under the conditions of 3500G and 5 minutes, and (iv) the supernatant was removed. The steps (i) to (iv) were repeated 11times in total. Finally, centrifugation was performed under the conditions of 3500G and 5 minutes using a centrifuge, and then the supernatant was discarded to obtain a V₄C₃Tₛ-water medium clay.

### (4) Intercalation of Dispersion Medium by Mixing With High Relative Permittivity Dispersion Medium (N-methylformamide)

The V₄C₃Tₛ-water medium clay prepared by the above method and N-methylformamide (NMF) as the high relative permittivity dispersion medium were mixed under the following conditions to perform intercalation of NMF.

### Mixing Condition With High Relative Permittivity Dispersion Medium (N-methylformamide))

V₄C₃Tₛ-water medium clay (MXene after washing): Solid content: 0.5 g
Dispersion medium: NMF 20 mL
Reaction vessel: 100 mL Eye Boy
Temperature: 20 to 25° C. (room temperature)
Stirring time: 11 h
Stirring rotation speed: 700 rpm

### (5) Delamination

The slurry obtained by mixing with the NMF was transferred to a 50 mL centrifuge tube, 20 mL of NMF was added, and then centrifugation was performed under the conditions of 3500G and 5 min using a centrifuge, and then the supernatant was recovered. Thereafter, (i) 35 mL of NMF was added to the supernatant, (ii) the mixture was stirred for 15 minutes by a shaker, (iii) the mixture was centrifuged under the conditions of 3500G and 5 minutes, and (iv) the supernatant containing MXene formed into a single layer was recovered. The steps (i) to (iv) were repeated four times in total to recover all the supernatant. Thereafter, the obtained supernatant was centrifuged under the conditions of 4300G for 2 hours using a centrifuge to precipitate MXene, and the supernatant was discarded. Then, the precipitate was obtained as the two-dimensional particle-containing composition.

### Comparative Example 1

### Fabrication of Two-Dimensional Particle

In Comparative Example 1, a two-dimensional particle was fabricated by performing (1) preparation of a precursor (MAX), (2) etching of the precursor, (3) washing, (4) intercalation, and (5) delamination and washing in the same manner as in Example 1 to obtain a delaminated material, and then performing the following step (7). Preparation and heating of the precursor film were sequentially performed to prepare an electroconductive film containing the two-dimensional particle.

### (7) Preparation and Heating of Precursor Film

The delaminated material was taken in a predetermined amount in a 50 mL centrifuge tube, and pure water was added thereto. At this time, the amount of pure water added was adjusted so that the concentration of the delaminated material in the mixture was 1.5 mass %. Thereafter, the mixture was stirred for 15 minutes by a shaker to obtain a slurry.

The slurry was subjected to suction filtration to fabricate a filtration film. As a filter for suction filtration, a membrane filter (Durapore, manufactured by Merck Corporation, pore size 0.45 μm) was used. The filtration film was dried at 150° C. for 16 hours using a vacuum oven to prepare a precursor film.

The obtained film was placed in a vacuum oven and heated under the conditions of an absolute pressure of 912 hPa (gauge pressure of −0.1 MPa) and 200° C. for 12 hours to prepare a film.

### Gas Chromatography-Mass Spectrometry

The two-dimensional particles obtained in examples and comparative examples were heated to 450° C. using a pyrolyzer (“PY-2020i” manufactured by Frontier Laboratories, Inc.) to desorb the gas adsorbed on the surface of the layer of the two-dimensional particle. The gas desorbed from the two-dimensional particle was subjected to mass spectrometry using a gas chromatography-mass spectrometer (“7890A/5975C” manufactured by Agilent Technologies, Inc.).

### Carbon/Sulfur Analysis

CO and CO₂ generated when the two-dimensional particles obtained in examples and comparative examples were heated in an oxygen stream together with a combustion aid (metal W, metal Sn) were qualitatively and quantitatively determined using a carbon/sulfur analyzer (“EMIA-920V2/FA” manufactured by HORIBA, Ltd.), thereby calculating the total content of carbon atoms in the two-dimensional particles.

A value obtained by dividing the weight of the two-dimensional particle subjected to the measurement by the formula weight of Ti₃C₂O₂ and multiplying the obtained value by the formula weight of C2 was defined as the content of carbon atoms derived from the layer of the two-dimensional particle. The content of carbon atoms derived from the hydrocarbon compound in the two-dimensional particle was calculated by subtracting the content of carbon atoms derived from the layer of the two-dimensional particle from the value of the total content of carbon atoms in the two-dimensional particle.

### X-ray Photoelectron Spectroscopy

The electroconductive films obtained in examples and comparative examples were subjected to X-ray photoelectron spectroscopy under the following conditions using an X-ray photoelectron spectrometer (“PHI Quantes” manufactured by ULVAC-PHI, Inc.). Next, based on the obtained spectrum, the ratio of the area of the peaks attributed to divalent and trivalent Ti to the total area of the peaks attributed to Ti2p was calculated.

### Conditions for X-ray Photoelectron Spectroscopy Measurement

X-ray source: Al monochrome Kα(25 W, 15 kV)

Analysis range: 100 μmφ

Photoelectron extraction angle: 45° with respect to sample surface

### Measurement of Electrical Conductivity

The electrical conductivity of the obtained electroconductive film was determined. As for the electrical conductivity, the resistivity (106 ) and the thickness (μm) were measured at three points per sample, the electrical conductivity (S/cm) was calculated from these measured values, and the average value of three electrical conductivities obtained by this calculation was adopted. In the resistivity measurement, the surface resistance of the film was measured by a four-terminal method using a simple low resistivity meter (Loresta AX MCP-T370, manufactured by Mitsubishi Chemical Analytech Co., Ltd.). In the thickness measurement, a micrometer (MDH-25MB, manufactured by Mitutoyo Corporation) was used. The volume resistivity was determined from the obtained surface resistance and film thickness, and the electrical conductivity was determined by taking the reciprocal of the value.

### Heat Treatment

The two-dimensional particles obtained in examples and comparative examples were subjected to a heat treatment at 300° C. for 2 hours under normal pressure in the air.

TABLE 1

| | | Example 1 | Example 2 | |
|---|---|---|---|---|
| | | toluene, xylene, propene, | toluene, xylene, propene, | |
| | | isobutane, isobutene, | isobutane, isobutene, | |
| | | 2-methylbutane, pentene, | 2-methylbutane, pentene, | |
| | | 2-methylbutene, | 2-methylbutene, | |
| | | 2-methylpentane, | 2-methylpentane, | |
| | | 2-methylpentene, | 2-methylpentene, | |
| | | 2,4-dimethylpentane, | 2,4-dimethylpentane, | |
| | | 2-methylhexene, | 2-methylhexene, | Comparative |
| | | 2-methylheptane, | 2-methylheptane, | Example 1 |
| Hydrocarbon compound | | octene, octane, butane | octene, octane, butane | toluene, xylene |
| Content of carbon atoms derived | | 2.3 mass % | 1.7 mass % | 0.3 mass % |
| from hydrocarbon compound | | | | |
| Ti2p area | Before heat treatment | 95% | 95% | 96% |
| ratio | After heat treatment | 94% | 94% | 76% |
| Electrical | Before heat treatment | 6,200 | 1,500 | 6,700 |
| conductivity | After heat treatment | 6,500 | 1,500 | 4,800 |

Examples 1 and 2 are examples of the present disclosure, and it was verified that the two-dimensional particles comprise a hydrocarbon compound. In addition, it was verified that in the electroconductive film obtained using the two-dimensional particle, the electrical conductivity is increased before and after the heat treatment at 300° C., and in particular, the decrease in electrical conductivity is suppressed even in a high-temperature environment, and the electrical conductivity is increased in some cases.

Comparative Example 1 is an example in which the two-dimensional particle and the electroconductive film were fabricated without using N-methylformamide, and it was verified that the electrical conductivity easily decreases, and particularly the electrical conductivity decreases under a high-temperature environment.

### REFERENCE SIGNS LIST

1a, 1b Layer body (MₘXₙ layer)
3a, 5a, 3b, 5b Modifier or terminal T
7a, 7b MXene layer
10, 10a, 10b MXene particle (two-dimensional particle of layered material)

1. A two-dimensional particle comprising:
one or plural layers that comprise a layer body represented by: 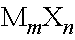
wherein M is at least one metal of Group 3, 4, 5, 6, or 7; X is a carbon atom, a nitrogen atom, or a combination thereof; n is 1 to 4; and m is more than n but not more than 5,
a modifier or terminal T exists on a surface of the layer body, wherein T is at least one selected from a hydroxyl group, a fluorine atom, a chlorine atom, an iodine atom, an oxygen atom, a chlorine atom, a phosphorus atom, and a hydrogen atom; and
a hydrocarbon compound exists on the one or plural layers.

2. The two-dimensional particle according to claim 1, wherein the hydrocarbon compound has 3 to 10 carbon atoms.

3. The two-dimensional particle according to claim 1, wherein the hydrocarbon compound comprises one or more of an aromatic hydrocarbon compound, a saturated or unsaturated aliphatic hydrocarbon compound, or a saturated or unsaturated alicyclic hydrocarbon compound.

4. The two-dimensional particle according to claim 1, wherein a content of carbon atoms derived from the hydrocarbon compound is 0.5 mass % or more in 100 mass % of a total amount of the two-dimensional particle.

5. The two-dimensional particle according to claim 1, wherein a content of carbon atoms derived from the hydrocarbon compound is 0.5 mass % to 3.0 mass % in 100 mass % of a total amount of the two-dimensional particle.

6. The two-dimensional particle according to claim 1, further comprising one or more metal atoms selected from Li, K, Na, Mg, Mn, Ca, Fe, Zn, Al, and Cu.

7. An electroconductive film comprising the two-dimensional particle according to claim 1, wherein the electroconductive film has an electrical conductivity is 2,000 S/cm or more.

8. A method for producing a two-dimensional particle, the method comprising:
heating a precursor particle in the presence of an organic compound under conditions of an absolute pressure of less than 1,013 hPa and a boiling point of the organic compound or higher to obtain a two-dimensional particle,
wherein the precursor particle comprises one or plural layers,
wherein the one or plural layers comprise a layer body represented by: 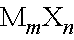
wherein M is at least one metal of Group 3, 4, 5, 6, or 7; X is a carbon atom, a nitrogen atom, or a combination thereof;
n is 1 to 4; and m is more than n but not more than 5,
a modifier or terminal T exists on a surface of the layer body, and where T is at least one selected from a hydroxyl group, a fluorine atom, a chlorine atom, an iodine atom, an oxygen atom, a chlorine atom, a phosphorus atom, and a hydrogen atom, and
wherein the organic compound has a melting point of 20° C. or lower.

9. The method for producing a two-dimensional particle according to claim 8, wherein the organic compound has one or more of a carbonyl group, an ester group, an amide group, a formamide group, a carbamoyl group, a carbonate group, an aldehyde group, an ether group, a sulfonyl group, a sulfinyl group, a hydroxyl group, a cyano group, and a nitro group.

10. The method for producing a two-dimensional particle according to claim 8, wherein the organic compound has a relative permittivity of 60 or more.

11. The method for producing a two-dimensional particle according to claim 8, wherein the organic compound has a relative permittivity of 60 to 300.

12. The method for producing a two-dimensional particle according to claim 8, wherein the precursor particle is produced by:
(a) preparing a precursor represented by: 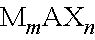
wherein M is at least one metal of Group 3, 4, 5, 6, or 7; X is a carbon atom, a nitrogen atom, or a combination thereof; A is at least one element of Group 12, 13, 14, 15, or 16; n is 1 to 4; and m is more than n but not more than 5;
(b) removing at least some A atoms from the precursor using an etching liquid to obtain an etched material;
(c) mixing the etched material with an intercalator to obtain an intercalated material; and
(d) stirring the intercalated material to obtain a delaminated material comprising the precursor particle.

13. The method for producing a two-dimensional particle according to claim 8, wherein the melting point of the organic compound is −50° C. to 5° C.

14. The method for producing a two-dimensional particle according to claim 8, wherein the boiling point of the organic compound is 285° C. or lower.

15. The method for producing a two-dimensional particle according to claim 8, wherein a Hildebrand solubility parameter of the organic compound is 19.0 MPa^{1/2} or more.

16. The method for producing a two-dimensional particle according to claim 8, wherein a Hildebrand solubility parameter of the organic compound is 19.0 MPa^{1/2} to 47.8 MPa^{1/2}.

17. The method for producing a two-dimensional particle according to claim 8, wherein an amount of the organic compound is 5 to 100 parts by mass with respect to 1 part by mass of the precursor particle.
